(19) United States
(12) Patent Application Publication
(10) Pub. No.: US 2003/0139432 A1
(43) Pub. Date: Jul. 24, 2003

(54) Method of inducing the virus resistance in plants

(76) Inventors: Harald Kohle, Bobenheim (DE); Uwe Conrath, Kaiserslautern (DE); Kai Seehaus, Landau (DE)

Correspondence Address: KEIL & WEINKAUF, 1350 CONNECTICUT AVENUE, N.W., WASHINGTON, DC, 20036, US

(21) Appl. No.: 10/257,874

(22) PCT Filed: Apr. 30, 2001
(86) PCT No.: PCT/EP01/04889

(30) Foreign Application Priority Data
May 3, 2000 (DE) 100 21 190.9

(51) Int. Cl. A01N 43/54; A01N 43/40; A01N 43/56; A01N 37/34; A01N 37/12; A01N 37/44; A01N 37/10

(52) U.S. Cl. 514/269; 514/345; 514/522; 514/534; 514/543; 514/407

(57) ABSTRACT

A method of inducing the viral resistance of plants comprises treating the plants, the soil or seeds with an effective amount of the compound of the formula I

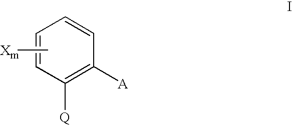

in which

p0 X is halogen, C₁-C₄-alkyl or trifluoromethyl;

m is 0 or 1;

Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃;

A is —O—B, —CH₂O—B, —OCH₂—B, —CH═CH—B, —C≡C—B, —CH₂O—N═C (R¹) —B or —CH₂O—N═C (R¹) —C (R²) ═N—OR³, where

B is optionally substituted phenyl, naphthyl, 5-membered or 6-membered hetaryl or 5-membered or 6-membered heterocyclyl, containing one to three N atoms and/or one O or S atom or one or two O and/or S atoms;

R¹ is hydrogen, cyano, alkyl, haloalkyl, cycloalkyl, alkoxy;

R² is optionally substituted phenyl, phenylcarbonyl, phenylsulfonyl, 5- or 6-membered hetaryl, 5- or 6-membered hetarylcarbonyl or 5- or 6-membered hetarylsulfonyl, or

alkyl, cycloalkyl, alkenyl, alkynyl, alkylcarbonyl, alkenylcarbonyl, alkynylcarbonyl, alkylsulfonyl, or C(═NOR^{α}) —OR^{β}; and

R³ is hydrogen, optionally substituted alkyl, alkenyl, alkynyl;

which compound is taken up by the plants or seeds.

The present invention relates to a method of inducing the virus resistance of plants which comprises treating the plants, the soil or seeds with an effective amount of a compound of the formula I

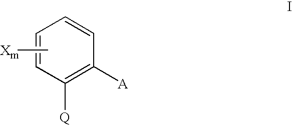

in which

X is halogen, C₁-C₄-alkyl or trifluoromethyl;

m is 0 or 1;

Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃;

A is —O—B, —CH₂O—B, —OCH₂—B, —CH═CH—B, —C≡C—B, —CH₂O—N═C (R¹) —B or —CH₂O—N═C (R¹) —C (R²) ═N—OR³, where

B is phenyl, naphthyl, 5-membered or 6-membered hetaryl or 5-membered or 6-membered heterocyclyl, containing one to three N atoms and/or one O or S atom or one or two O and/or S atoms, the ring systems being unsubstituted or substituted by one to three radicals R^{a}:

R^{a} is cyano, nitro, amino, aminocarbonyl, aminothio-carbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkyl-thio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR^{α})—OR^{β} or OC (R^{α})₂-C (R^{β})═NOR^{β}, the cyclic radicals, in turn, being unsubstituted or substituted by one to three radicals R^{b}:

R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cyclo-alkenyl, phenyl, phenoxy, phenylthio, benzyl, benzyloxy, 5- or 6-membered heterocyclyl, 5- or 6-membered hetaryl, 5- or 6-membered hetaryloxy or C(═NOR^{α})—OR^{β};

R^{α}, R^{β} are hydrogen or C₁-C₆-alkyl;

R¹ is hydrogen, cyano, C₁-C₄-alkyl, C₁-C₄-haloalkyl, C₃-C₆-cycloalkyl, C₁-C₄-alkoxy;

R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},

C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenyl-carbonyl, C₃-C₁₀-alkynylcarbonyl, C₁-C₁₀-alkylsulfonyl, or C(═NOR^{α})—OR^{β}, the hydrocarbon radicals of these groups being unsubstituted or substituted by one to three radicals R^{c}:

R^{c} is cyano, nitro, amino, aminocarbonyl, aminothio-carbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkyl-amino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy,

C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and

R³ is hydrogen, C₁-C₆-alkyl, C₂-C₆-alkenyl, C₂-C₆-alkynyl, the hydrocarbon radicals of these groups being unsubstituted or substituted by one to three radicals R^{c};

which compound is taken up by the plants or seeds. In addition, the invention generally relates to the use of the compounds of the formula I for inducing the virus resistance of plants.

A large number of representatives of the highly heterogeneous group of plant viruses (phytophages) are capable of attacking economically relevant plants; the symptoms of the damage range from morphological modifications to the death of the plants. The very many ways in which viruses are transmitted (for example mechanically via wounding, via seeds and pollen, or via vectors such as nematodes and insects), the problems of diagnosis and the lack of suitable active ingredients make the control of such viruses extraordinarily difficult; the emphasis is therefore on preventative and phytosanitary measures. Accordingly, preventing viral diseases in plants is an important aim in agriculture.

The search for methods for preventing viral diseases in plants has already yielded antiviral active ingredients, some of which resemble nucleic acids. However, some of these substances generate mutants and inhibit the metabolism of nucleic acids and proteins in the host cells, giving rise to damage. In the field, these materials have only a small actual control effect.

A sophisticated principle is the utilization, or stimulation, of the plants' intrinsic defenses:

DE-A 39 34 761 proposes polylysine and alkyldiethylene-triaminoacetic acids for preventing viral diseases of plants. EP-A 420 803 describes the immunizing effect of benzo-1,2,3-thiazole derivatives against various phytopathogenic microorganisms. WO-A 96/37493 discloses a similar effect of pyridylthiazoles.

DD 280 030 proposes sulfonic acid derivatives as agents for activating the resistance of crop plants and useful plants. However, the action of these substances is unsatisfactory in many cases.

It is an object of the present invention to provide a method which can be used broadly, which does not damage the plants and which brings about effective immunization of the plants against viral diseases.

We have found that this object is achieved by the method defined at the outset. The active ingredients used are known as fungicides and, in some cases, also as insecticides (EP-A 178 826; EP-A 253 213; WO-A 93/15046; WO-A 95/18789; WO-A 95/21153; WO-A 95/21154; WO-A 95/24396; WO-A 96/01256; WO-A 97/15552). However, there has been no suggestion to date that these active ingredients might have a stimulatory effect on the plants' intrinsic immune system against viruses.

The good compatibility, with plants, of the active ingredients of the formula I at the concentrations required for controlling plant diseases permits the treatment of aerial plant parts and also the treatment of propagation material and seed, and of the soil.

In the method according to the invention, the active ingredient is taken up by the plant either through the leaf surface or through the roots and is distributed within the entire plant in the sap.

Thus, the protective action after carrying out the method according to the invention is not just found in those plant parts which have been sprayed directly, but the resistance to viral diseases of the entire plant is increased.

In a preferred embodiment of the method, the aerial plant parts are treated with a formulation of the active ingredient I.

The publications cited at the outset describe synthesis routes for the preparation of the active ingredients used in the method according to the invention, the disclosure of which is hereby incorporated.

Especially preferred for the method according to the invention are active ingredients with the following meanings of the substituents, in each case alone or in combination, the disclosure of the publications cited being hereby incorporated:

Especially preferred for the method according to the invention are, in particular, the active ingredients of the formulae II to VIII, in which

V is OCH₃ and NHCH₃,

Y is CH and N and

T and Z independently of one another are CH and N.

Preferred active ingredients of the formula I in which Q is N(—OCH₃)—COOCH₃ are the compounds described in the publications WO-A 93/15046 and WO-A 96/01256.

Preferred active ingredients of the formula I in which Q is C(═CH—OCH₃)—COOCH₃ are the compounds described in the publications EP-A 178 826 and EP-A 278 595.

Preferred active ingredients of the formula I in which Q is C(═N—OCH₃)—COOCH₃ are the compounds described in the publications EP-A 253 213 and EP-A 254 426.

Preferred active ingredients of the formula I in which Q is C(═N—OCH₃)—CONHCH₃ are the compounds described in the publications EP-A 398 692, EP-A 477 631 and EP-A 628 540.

Preferred active ingredients of the formula I in which Q is C(═CH—CH₃)—COOCH₃ are the compounds described in the publications EP-A 280 185 and EP-A 350 691.

Preferred active ingredients of the formula I in which Q is —CH₂O—N═C (R¹) —B are the compounds described in the publications EP-A 460 575 and EP-A 463 488.

Preferred active ingredients of the formula I in which A is —O—B are the compounds described in the publications EP-A 382 375 and EP-A 398 692.

Preferred active ingredients of the formula I in which A is —CH₂O—N═C (R¹) —C (R²) ═N—OR³ are the compounds described in the publications WO-A 95/18789, WO-A 95/21153, WO-A 95/21154, WO-A 97/05103 and WO-A 97/06133.

Especially preferred are the active ingredients of the formula I in which

Q is N(—OCH₃)—COOCH₃,

A is CH₂—O— and

B is 3-pyrazolyl or 1,2,4-triazolyl, where B has attached to it one or two substituents selected from the group of

halogen, methyl and trifluoromethyl and

phenyl and pyridyl, in particular 2-pyridyl, substituted by 1 to 3 radicals R^{b}.

These active ingredients are described by the formula II.

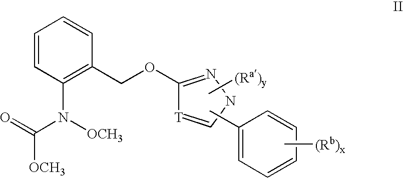

Other active ingredients which are especially preferred are those of the formula II'.

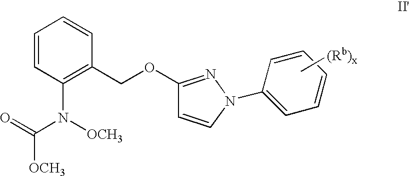

With regard to their use, the compounds compiled in the tables which follow are especially preferred.

TABLE I

| | |
|---|---|
| | II |
| 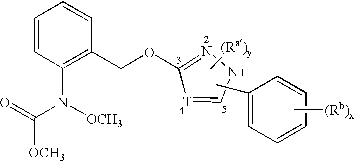 | |

| | | | Position of the | | |
|---|---|---|---|---|---|
| No. | T | (R^{a′})_{y} | group phenyl- (R^{b})ₓ | (R^{b})ₓ | Reference |
| I-1 | N | — | 1 | 2,4-Cl₂ | WO-A 96/01256 |
| I-2 | N | — | 1 | 4-Cl | WO-A 96/01256 |
| I-3 | CH | — | 1 | 2-Cl | WO-A 96/01256 |
| I-4 | CH | — | 1 | 3-Cl | WO-A 96/01256 |
| I-5 | CH | — | 1 | 4-Cl | WO-A 96/01256 |
| I-6 | CH | — | 1 | 4-CH₃ | WO-A 96/01256 |
| I-7 | CH | — | 1 | H | WO-A 96/01256 |
| I-8 | CH | — | 1 | 3-CH₃ | WO-A 96/01256 |
| I-9 | CH | 5-CH₃ | 1 | 3-CF₃ | WO-A 96/01256 |
| I-10 | CH | 1-CH₃ | 5 | 3-CF₃ | WO-A 99/33812 |
| I-11 | CH | 1-CH₃ | 5 | 4-Cl | WO-A 99/33812 |
| I-12 | CH | 1-CH₃ | 5 | — | WO-A 99/33812 |

TABLE II

| | |
|---|---|
| | III |
| 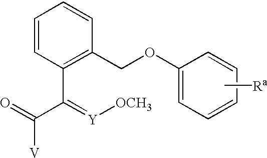 | |

| No. | V | Y | R^{a} | Reference |
|---|---|---|---|---|
| II-1 | OCH₃ | N | 2-CH₃ | EP-A 253 213 |
| II-2 | OCH₃ | N | 2,5-(CH₃)₂ | EP-A 253 213 |
| II-3 | NHCH₃ | N | 2,5-(CH₃)₂ | EP-A 398 692 |
| II-4 | NHCH₃ | N | 2-Cl | EP-A 398 692 |
| II-5 | NHCH₃ | N | 2-CH₃ | EP-A 398 692 |
| II-6 | NHCH₃ | N | 2-CH₃, 4-OCF₃ | EP-A 628 540 |
| II-7 | NHCH₃ | N | 2-Cl, 4-OCF₃ | EP-A 628 540 |
| II-8 | NHCH₃ | N | 2-CH₃, 4-OCH(CH₃)—C(CH₃)═NOCH₃ | DE Appl. 10002661.3 |
| II-9 | NHCH₃ | N | 2-Cl, 4-OCH(CH₃)—C(CH₃)═NOCH₃ | DE Appl. 10002661.3 |
| II-10 | NHCH₃ | N | 2-CH₃, 4-OCH(CH₃)—C(CH₂CH₃)═NOCH₃ | DE Appl. 10002661.3 |
| II-11 | NHCH₃ | N | 2-Cl, 4-OCH(CH₃)—C(CH₃)═NOCH₂CH₃ | DE Appl. 10002661.3 |

TABLE III

| | |
|---|---|
| | IV |
| 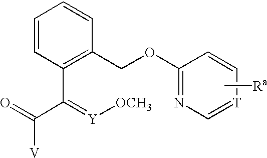 | |

| No. | V | Y | T | R^{a} | Reference |
|---|---|---|---|---|---|
| III-1 | OCH₃ | CH | N | 2-OCH₃, 6-CF₃ | WO-A 96/16047 |
| III-2 | OCH₃ | CH | N | 2-OCH(CH₃)₂, 6-CF₃ | WO-A 96/16047 |
| III-3 | OCH₃ | CH | CH | 5-CF₃ | EP-A 278 595 |
| III-4 | OCH₃ | CH | CH | 6-CF₃ | EP-A 278 595 |
| III-5 | NHCH₃ | N | CH | 3-Cl | EP-A 398 692 |
| III-6 | NHCH₃ | N | CH | 3-CF₃ | EP-A 398 692 |
| III-7 | NHCH₃ | N | CH | 3-CF₃, 5-Cl | EP-A 398 692 |
| III-8 | NHCH₃ | N | CH | 3-Cl, 5-CF₃ | EP-A 398 692 |

TABLE IV

| | |
|---|---|
| | V |
| 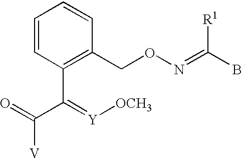 | |

| No. | V | Y | R¹ | B | Reference |
|---|---|---|---|---|---|
| IV-1 | OCH₃ | CH | CH₃ | (3-CF₃)C₆H₄ | EP-A 370 629 |
| IV-2 | OCH₃ | CH | CH₃ | (3,5-Cl₂)C₆H₃ | EP-A 370 629 |
| IV-3 | NHCH₃ | N | CH₃ | (3-CF₃)C₆H₄ | WO-A 92/13830 |
| IV-4 | NHCH₃ | N | CH₃ | (3-OCF₃)C₆H₄ | WO-A 92/13830 |
| IV-5 | OCH₃ | N | CH₃ | (3-OCF₃)C₆H₄ | EP-A 460 575 |
| IV-6 | OCH₃ | N | CH₃ | (3-CF₃)C₆H₄ | EP-A 460 575 |
| IV-7 | OCH₃ | N | CH₃ | (3,4-Cl₂)C₆H₃ | EP-A 460 575 |
| IV-8 | OCH₃ | N | CH₃ | (3,5-Cl₂)C₆H₃ | EP-A 463 488 |

TABLE V

| | |
|---|---|
| | VI |
| 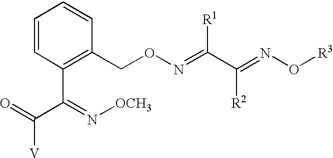 | |

| No. | V | R¹ | R² | R³ | Reference |
|---|---|---|---|---|---|
| V-1 | OCH₃ | CH₃ | CH₃ | CH₃ | WO-A |
| | | | | | 95/18789 |
| V-2 | OCH₃ | CH₃ | CH(CH₃)₂ | CH₃ | WO-A |
| | | | | | 95/18789 |
| V-3 | OCH₃ | CH₃ | CH₂CH₃ | CH₃ | WO-A |
| | | | | | 95/18789 |
| V-4 | NHCH₃ | CH₃ | CH₃ | CH₃ | WO-A |
| | | | | | 95/18789 |
| V-5 | NHCH₃ | CH₃ | 4-F—C₆H₄ | CH₃ | WO-A |
| | | | | | 95/18789 |
| V-6 | NHCH₃ | CH₃ | 4-Cl—C₆H₄ | CH₃ | WO-A |
| | | | | | 95/18789 |
| V-7 | NHCH₃ | CH₃ | 2,4-C₆H₃ | CH₃ | WO-A |
| | | | | | 95/18789 |
| V-8 | NHCH₃ | Cl | 4-F—C₆H₄ | CH₃ | WO-A |
| | | | | | 98/38857 |
| V-9 | NHCH₃ | Cl | 4-Cl—C₆H₄ | CH₂CH₃ | WO-A |
| | | | | | 98/38857 |
| V-10 | NHCH₃ | CH₃ | CH₂C(═CH₂)CH₃ | CH₃ | WO-A |
| | | | | | 97/05103 |
| V-11 | NHCH₃ | CH₃ | CH═C(CH₃)₂ | CH₃ | WO-A |
| | | | | | 97/05103 |
| V-12 | NHCH₃ | CH₃ | CH═C(CH₃)₂ | CH₂CH₃ | WO-A |
| | | | | | 97/05103 |
| V-13 | NHCH₃ | CH₃ | CH═C(CH₃)CH₂CH₃ | CH₃ | WO-A |
| | | | | | 97/05103 |
| V-14 | NHCH₃ | CH₃ | O—CH(CH₃)₂ | CH₃ | WO-A |
| | | | | | 97/06133 |
| V-15 | NHCH₃ | CH₃ | O—CH₂CH(CH₃)₂ | CH₃ | WO-A |
| | | | | | 97/06133 |
| V-16 | NHCH₃ | CH₃ | C(CH₃)═NOCH₃ | CH₃ | WO-A |
| | | | | | 97/15552 |

TABLE VI

| | |
|---|---|
| | VII |
| 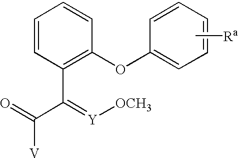 | |

| No. | V | Y | R^{a} | Reference |
|---|---|---|---|---|
| VI-1 | NHCH₃ | N | H | EP-A 398 692 |
| VI-2 | NHCH₃ | N | 3-CH₃ | EP-A 398 692 |
| VI-3 | NHCH₃ | N | 2-NO₂ | EP-A 398 692 |
| VI-4 | NHCH₃ | N | 4-NO₂ | EP-A 398 692 |
| VI-5 | NHCH₃ | N | 4-Cl | EP-A 398 692 |
| VI-6 | NHCH₃ | N | 4-Br | EP-A 398 692 |

TABLE VII

| | |
|---|---|
| | VIII |
| 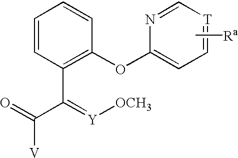 | |

| No. | V | Y | T | R^{a} | Reference |
|---|---|---|---|---|---|
| VII-1 | OCH₃ | CH | N | 6-O-(2-CN—C₆H₄) | EP-A |
| | | | | | 382 375 |
| VII-2 | OCH₃ | CH | N | 6-O-(2-Cl—C₆H₄) | EP-A |
| | | | | | 382 375 |
| VII-3 | OCH₃ | CH | N | 6-O-(2-CH₃—C₆H₄) | EP-A |
| | | | | | 382 375 |
| VII-4 | NHCH₃ | N | N | 6-O-(2-Cl—C₆H₄) | GB-A |
| | | | | | 2253624 |
| VII-5 | NHCH₃ | N | N | 6-O-(2,4-Cl₂—C₆H₃) | GB-A |
| | | | | | 2253624 |
| VII-6 | NHCH₃ | N | N | 6-O-(2-CH₃—C₆H₄) | GB-A |
| | | | | | 2253624 |
| VII-7 | NHCH₃ | N | N | 6-O-(2-CH₃, 3-Cl—C₆H₃) | GB-A |
| | | | | | 2253624 |
| VII-8 | NHCH₃ | N | N | 2-F, 6-O-(2-CH₃—C₆H₄) | WO-A |
| | | | | | 98/21189 |
| VII-9 | NHCH₃ | N | N | 2-F, 6-O-(2-Cl—C₆H₄) | WO-A |
| | | | | | 98/21189 |
| VII-10 | NHCH₃ | N | N | 2-F, 6-O-(2-CH₃, 3-Cl—C₆H₃) | WO-A |
| | | | | | 98/21189 |

Especially preferred are, in particular, the active ingredients I-5 (common name: pyraclostrobin), III-4 (common name: picoxystrobin), IV-3 (common name: trifloxystrobin) and VII-1 (common name: azoxystrobin).

The compounds I increase the resistance of plants to viruses. They are especially important for controlling viruses on diverse crop plants such as tobacco, barley, cucumber, potatoes and beet, and on the seeds of these plants.

Specifically, they are suitable for controlling the following plant diseases:

in tobacco, the tobacco mosaic virus and the tobacco necrosis virus,

in beans, the bean common mosaic virus and the bean yellow mosaic virus,

in barley, the barley stripe mosaic virus and the barley yellow dwarf virus,

in cucumbers, the cucumber green mottle mosaic virus and the cucumber mosaic virus,

in potatoes, the potato X virus and the potato Y virus,

in beet, rhizomania and beet mild yellowing virus.

The compounds I are applied by treating the soil or the seeds or plants to be protected against viral attack with an effective amount of the active ingredients. Application can be effected both before and after infection of the plants or seeds by the viruses.

In a preferred embodiment of the method, the plant is treated before infection takes place. A markedly reduced susceptibility of the plant to viral diseases is observed.

For use in crop protection, the application rates are between 0.01 and 2.0 kg of active ingredient per hectare, depending on the type of pathogen and the plant species.

In the treatment of seed, amounts of from 0.001 to 0.1 g, preferably 0.01 to 0.05 g, of active ingredient are generally required per kilogram of seed.

The compounds I can be converted into the formulations conventionally used for fungicides, for example solutions, emulsions, suspensions, dusts, powders, pastes and granules. The use form depends on the particular purpose; in any case, it should ensure fine and uniform distribution of the compound according to the invention.

The formulations are prepared in a known manner, for example by extending the active ingredient with solvents and/or carriers, if required using emulsifiers and dispersants, it also being possible to use other organic solvents as cosolvents if water is used as the diluent. Auxiliaries which are suitable are essentially those which are also conventionally used in fungicides. In general, the formulations comprise between 0.01 and 95% by weight, preferably between 0.1 and 90% by weight, of the active ingredient. The active ingredients are employed in a purity of from 90% to 100%, preferably 95% to 100% (according to NMR spectrum).

Examples of formulations are:

I. 5 parts by weight of a compound according to the invention are mixed intimately with 95 parts by weight of finely divided kaolin. This gives a dust comprising 5% by weight of the active ingredient.

II. 30 parts by weight of a compound according to the invention are mixed intimately with a mixture of 92 parts by weight of pulverulent silica gel and 8 parts by weight of mineral oil which has been sprayed onto the surface of this silica gel. This gives a preparation of the active ingredient with good adhesion properties (active ingredient content 23% by weight).

III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (active ingredient content 9% by weight).

IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (active ingredient content 16% by weight).

V. 80 parts by weight of a compound according to the invention are mixed thoroughly with 3 parts by weight of sodium diisobutylnaphthalene-α-sulfonate, 10 parts by weight of the sodium salt of a lignosulfonic acid froma sulfite waste liquor and 7 parts by weight of pulverulent silica gel, and the mixture is ground in a hammer mill (active ingredient content 80% by weight).

VI. 90 parts by weight of a compound according to the invention are mixed with 10 parts by weight of N-methyl-α-pyrrolidone, which gives a solution which is suitable for use in the form of microdrops (active ingredient content 90% by weight).

VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100 000 parts by weight of water and finely distributing it therein gives an aqueous dispersion comprising 0.02% by weight of the active ingredient.

VIII. 20 parts by weight of a compound according to the invention are mixed thoroughly with 3 parts by weight of sodium diisobutylnaphthalene-α-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20 000 parts by weight of water gives a spray mixture comprising 0.1% by weight of the active ingredient.

Aqueous use forms can conventionally be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of wetter, adhesive, dispersant or emulsifier. Alternatively, concentrates composed of active substance, wetter, adhesive, dispersant or emulsifier and, if appropriate, solvent or oil can be prepared, and these concentrates are suitable for dilution with water.

The active ingredient concentrations in the ready-to-use preparations can be varied within substantial ranges. In general, they are between 0.0001 and 10%, preferably between 0.01 and 1%.

The active ingredients can also be used very successfully in the ultra-low volume (ULV) method, it being possible to apply formulations with over 95% by weight of active ingredient, or even the active ingredient without additives.

Various types of oils, or herbicides, other fungicides, other pesticides, bactericides may be added to the active ingredients, if appropriate also only just prior to use (tank mix). These agents can be admixed with the agents according to the invention in the weight ratio 1:10 to 10:1.

The note mentioning the effect of the active ingredients I in inducing resistance to viruses may be present as a label on the packaging or in product data sheets. The note may also be present in the case of preparations which can be used in combination with the active ingredients I.

The induction of resistance may also constitute an indication which may be the subject of official approval of the active ingredients I.

The action of the compounds of the general formula I was demonstrated by the following experiments:

Use examples for induction of resistance to viruses

Plant Material

For the experiments, tobacco plants (Nicotiana tabacum cv. Xanthi-nc) were grown at 25° C., an atmospheric humidity of 59% and a daily photoperiod of 16 hours (150-200 μM quanta/s⁻¹/m⁻²) for 4 to 5 weeks in potting compost (standard soil type ED 73). Some of the plants were fed once per week by adding a commercial house-plant fertilizer (10% total nitrogen, 9% phosphate, 7% potash) to the irrigation water at the recommended rate.

Application of the Active Ingredient

The formulated active ingredients used took the form of water-dispersible granules with an active ingredient content of 20%. The concentrations used in the experiments (0.01-10 mM) are based on the active ingredient content. To prevent distribution of the active ingredient in the entire plant, the stalks of plants where a leaf had been infiltrated were removed above the treated leaf, using a sterile surgical blade.

After the application of the active ingredient, and also after infection with the virus at a later time, the plants were left to stand in the growth cabinet.

Virus infection and resistance assessment (following Malamy et al., SCIENCE, Vol. 250, pp. 1002-1004 (1990)):

The various pretreated tobacco plants were infected with tobacco mosaic virus (TMV, strain U1). To this end, a viral stock solution was diluted with 50 mM phosphate buffer (pH 7) to a final concentration of 1 μg TMV coat protein/ml. Infection was carried out by gently rubbing leaves, whose surfaces had previously been sprinkled with silicon carbide, with a gauze bandage soaked in the TMV solution. Post-infection, the silicon carbide was rinsed from the leaves with a gentle water jet and the plants were left to stand under the above-described conditions. Infection with TMV was carried out 1 day after the pretreaatment. Five to 7 days post-infection, the diameter of 10 to 20 lesions on the leaves was determined.

The lesion diameter is a measure of the acquired resistance of the plants, the smallest lesions representing the highest acquired resistance.

### USE EXAMPLE 1

Individual leaves of the plants were perforated at several sites with a cannula, and the aqueous active ingredient solution was 25 injected into the leaf at the perforation sites using a syringe (application quantity 2 to 5 ml/leaf). The insoluble constituents of the active ingredient solution had previously been separated off either by sedimentation or by brief centrifugation (3 minutes at 5 000 g). In the case of the control plants, the leaves were injected with water.

After 7 days, the diameter of the lesions on the leaves caused by TMV was determined in millimeters [mm].

In this test, the plants treated with 1 mM of the active ingredient I-5 in Table I showed lesions averaging 2.35 mm and the plants treated with 2.5 mM showed 1.8 mm, while the plants treated with pure water as control showed lesions of 3.55 mm.

### USE EXAMPLE 2

One half of the treated leaf was infiltrated with the active ingredient solution (preparation as in Example 1), while the other half was infiltrated with water. This procedure was intended to exclude variations in the response between different leaves and to make possible a direct determination on the effect of the active ingredient.

After 5 days, the diameter of the lesions on the leaves caused by TMV was determined in millimeters [mm].

In this test the leaf zones treated with 0.5 and 1 mM of the active ingredient I-5 in Table I showed lesions averaging 2.75 and 2.85 mm, respectively, and the untreated leaf zones showed lesions of 4.15 and 4.25 mm, while the plants treated with pure water as control showed lesions of 3.2 and 3.35 mm.

### USE EXAMPLE 3

Leaf halves of approx. 5-week-old tobacco plants (cultivar Xanthi-nc) were infiltrated with 1 mM active ingredient solution in 1% aqueous ethanol; the leaf halves of the controls were infiltrated with 1% aqueous ethanol.

Infection with TMV was carried out 1 day after the treatment; the plants were evaluated after a further 5 days. The data shown are the averages of the leaf areas which had died owing to viral attack (lesions) at the infection site on leaf halves treated with active ingredient or untreated leaf halves (controls):

Area of the lesions in comparison with the control:

| Active ingredient | Area in percent |
|---|---|
| I-5 | 53.0% |
| II-3 | 68.1% |
| III-4 | 60.3% |
| IV-3 | 76.1% |
| V-16 | 63.8% |
| VII-1 | 62.1% |

### USE EXAMPLE 4

The procedure of Use Example 3 was followed, but infection was carried out 2 days after the treatment and the plants were evaluated after a further 5 days.

Area of the lesions in comparison with the control:

| Active ingredient | Area in percent |
|---|---|
| II-3 | 62.7% |
| III-4 | 78.4% |
| VII-1 | 70.4% |

### USE EXAMPLE 5

Spraying the leaves with active ingredient solutions

In each case 2 mM active ingredient were dissolved in water with the aid of a universal wetter in the ratio 1:1 (w/w) and sprayed onto leaf halves of 5-week-old tobacco plants (cultivar Xanthi-nc) (leaf halves of the controls were sprayed with dissolved wetter only).

Infection with TMV was carried out 5 days after the treatment, and the plants were evaluated after a further 4 days. The data shown are the averages of the leaf areas which had died owing to viral attack (lesions) at the infection site on leaf halves treated with active ingredient or untreated leaf halves (controls):

Area of the lesions in comparison with the control:

| Active ingredient | Area in percent |
|---|---|
| II-3 | 49.6% |
| III-4 | 73.6% |
| VII-1 | 68.3% |

We claim:

1. A method of inducing the virus resistance of plants which comprises treating the plants, the soil or seeds with an effective amount of a compound of the formula I 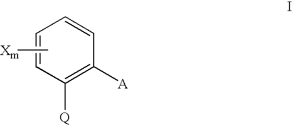
in which
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃;
A is —O—B, —CH₂O—B, —OCH₂—B, —CH═CH—B, —C≡C—B, —CH₂O—N═C (R¹) —B or —CH₂O—N═C (R¹) —C (R²) ═N—OR³, where
B is phenyl, naphthyl, 5-membered or 6-membered hetaryl or 5-membered or 6-membered heterocyclyl, containing one to three N atoms and/or one O or S atom or one or two O and/or S atoms, the ring systems being unsubstituted or substituted by one to three radicals R^{a}:
Ra is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR^{α})—OR^{β} or OC (R^{α})₂-C (R^{β})═NOR^{β}, the cyclic radicals, in turn, being unsubstituted or substituted by one to three radicals R^{b}:
R^{b} is cyano, nitro, halogen, amino, amino-carbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxy-carbonyl, C₁-C₆-alkylthio, C₁-C₆-alkylamino, di-C₁-C₆-alkylamino, C₁-C₆-alkylamino-carbonyl, di-C₁-C₆-alkylaminocarbonyl, C₁-C₆-alkylaminothiocarbonyl, di-C₁-C₆-alkyl-aminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C (═NOR^{α})—OR^{β};
R^{α}, R^{β} are hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy;
R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},
C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenyl-carbonyl, C₃-C₁₀-alkynylcarbonyl, C₁-C₁₀-alkyl-sulfonyl, or C(═NOR^{α})—OR^{β}, the hydrocarbon radicals of these groups being unsubstituted or substituted by one to three radicals R^{c}:
R^{c} is cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C6-alkylaminocarbonyl, di-C₁-C₆-alkylaminocarbonyl, C₁-C₆-alkylamino-thiocarbonyl, di-C₁-C₆-alkylaminothiocarbonyl, C₂-C₆-alkenyl, C₂-C₆-alkenyloxy,
C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and
R³ is hydrogen, C₁-C₆-alkyl, C₂-C₆-alkenyl, C₂-C₆-alkynyl, the hydrocarbon radicals of these groups being unsubstituted or substituted by one to three radicals R^{c};
which compound is taken up by the plants or seeds.

2. A method as claimed in claim 1, wherein the index m is zero and the substituents of formula I have the following meanings:
A is —O—B, —CH₂O—B, —CH₂O—N═C (R¹) —B or CH₂—O—N═C (R¹) —C (R²) ═N—OR³;
B is phenyl, pyridyl, pyrimidinyl, pyrazolyl, triazolyl, these ring systems being substituted by one or two radicals R^{a};
R² is C₁-C₆-alkyl, C₂-C₁₀-alkenyl, C₃-C₆-cycloalkyl, these groups being unsubstituted or substituted by one or two radicals R^{b}';
R^{b}' is C₁-C₆-alkyl, C₃-C₆-cycloalkyl, C₁-C₆-alkoxy, C₁-C₆-haloalkoxy, benzyl, phenyl or phenoxy;
phenyl which is unsubstituted or substituted by one or two radicals R^{a}; and
R³ is C₁-C₆-alkyl, C₂-C₁₀-alkenyl or C₂-C₁₀-alkynyl.

3. A method as claimed in claim 1 or 2, wherein an active ingredient of the formula II 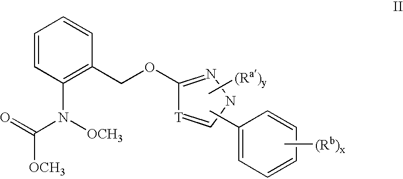
is used.

4. A method as claimed in claim 1 or 2, wherein an active ingredient of the formula III 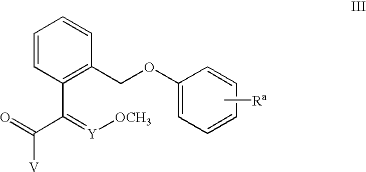
is used.

5. A method as claimed in claim 1 or 2, wherein an active ingredient selected from the group of I-5, III-4 and VII-1 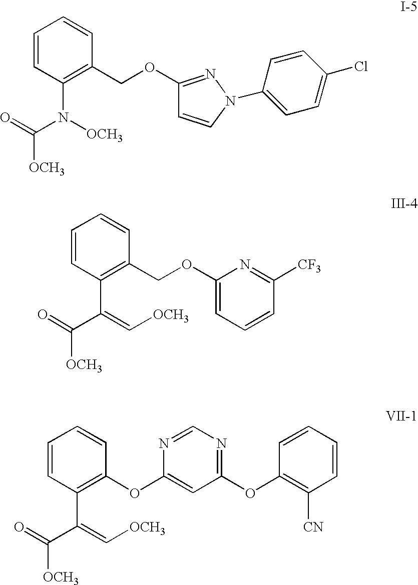
is used.

6. The use of the compounds of the formula I as claimed in any of claims 1 to 5 for inducing the virus resistance of plants.
